(19) United States
(12) Patent Application Publication
(10) Pub. No.: US 2007/0197056 A1
(43) Pub. Date: Aug. 23, 2007

(54) COMPUTER SYSTEM HAVING CUSTOMIZABLE PRINTED CIRCUIT BOARDS

(76) Inventors: Jian Huang, Singapore (SG); Yew Heng Seow, Singapore (SG); Pek Chuan Quek, Singapore (SG)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/674,174

(22) Filed: Feb. 13, 2007

Related U.S. Application Data
(60) Provisional application No. 60/774,788, filed on Feb. 17, 2006.

(51) Int. Cl. H01R 12/00

(52) U.S. Cl. 439/74

(57) ABSTRACT

A computer system includes a first circuit board and a second circuit board which is detachably coupled to the first circuit board via a specially designed I/O connector. When coupled together, the main board and the I/O card are positioned within a same plane by which, a computer system is configured with easy customizable printed circuit boards without substantially increase of the overall physical dimension. In the event that the first circuit board or the second circuit board needs to be modified, the two circuit boards can be detached from each other and after the modification, the two circuit boards can be coupled together again with the same connector to resume the functions of the computer system. Embodiments of the present invention provide effective and convenient solutions for reconfiguration, upgrading, addition and/or removal of external I/O ports in computer systems without redesigning and/or replacing the whole motherboard.

This application claims benefit of and priority from U.S. Provisional Patent Application No. 60/774,788, filed on 17 Feb. 2006, entitled “Customizable Printed Circuit Board”, which is hereby incorporated by reference.

### TECHNICAL FIELD OF THE INVENTION

The present invention relates to computer systems. In particular, it relates to computer systems having customizable printed circuit boards.

### BACKGROUND OF THE INVENTION

Printed Circuit Boards (PCBs) are widely used in electronics devices such as computer systems. Presently, main boards or motherboards used in computer systems all have the electronic components, such as the CPU and other integrated circuit chips, connectors as well as external Input/Output (I/O) interfaces, such as communications ports, Audio In/Out ports fixedly formed thereon.

External Input/Output (I/O) interfaces arranged in this matter, however, make it less flexible to customize or modify the design and configuration of the external I/O interfaces. In the event that newly developed external I/O interfaces are to be used, which has been taking place more and more often, the entire main board will have to be re-designed and re-fabricated. This will incur unnecessary costs and time.

Further, in the event that additional external I/O interfaces, for example additional communication ports or Universal Serial Bus (USB) ports are required, I/O expansion cards must be provided to connect the additional external I/O interface cards to the main board via Peripheral Component Interconnect (PCI) extension cards connected to the PCI slots. However, since all the PCI slots of present main boards are fixed at locations away from the I/O ports, connection cables become necessary to provide electrical connections between the PCI extension cards and the additional external I/O interface I/O cards. However, use of connection cables is costly and may give rise to reliability issues in the computer systems.

### SUMMARY OF THE INVENTION

Embodiments of the present invention provide effective and convenient solutions for reconfiguration, upgrading, addition and/or removal of external I/O ports in computer systems without redesigning and/or replacing the whole motherboard. Only the parts of the printed circuit board(s) with the I/O ports fixed thereon are to be changed or replaced. The other parts of the print circuit board(s) on which the CPU and other components are fixed, are not affected by the redesigning or replacement of the external I/O ports. Design and fabrication periods for customizing the I/O ports are much shortened, and unnecessary redesign and re-fabrication work on the other parts of the computer system, e.g. the main board, is generally avoided.

In one embodiment, a computer system includes a first circuit board and a second circuit board which is detachably coupled to the first circuit board. In the event that the first circuit board or the second circuit board needs to be modified, the two circuit boards can be detached from each other and after the modification, the two circuit boards can be coupled together again to resume the functions of the computer system.

The first circuit board may be a main board, and the second circuit board may be an I/O card. When coupled together, the main board and the I/O card are positioned within a same plane. By positioning the two circuit boards in a same plane, a computer system is configured with easy customizable printed circuit boards without substantially increase of the overall physical dimension of the computer system. Advantages offered by embodiments of the present invention are apparent in that, for example, the casing and chassis of the computer system can remain unchanged, hence a high level of compatibility to the industrial standard can be achieved.

In another embodiment, a computer system includes a main board and an I/O card which is detachably coupled to the main board. When the I/O card is coupled to the main board, an edge of the I/O card faces an edge of the main board.

### BRIEF DESCRIPTION OF THE DRAWINGS

These and other aspects and advantages of the present invention will be described in detail with reference to the accompanying drawings, in which:

FIG. 1 is a perspective view of a computer PCB assembly according to one embodiment of the present invention;

FIG. 2 is an exploded view of an embodiment of FIG. 1;

FIG. 3 is a top view of an embodiment of FIG. 1;

FIG. 4A is a perspective view of a computer PCB assembly according to another embodiment of the present invention;

FIG. 4B is an exploded view of an embodiment of FIG. 4A;

FIG. 5 is a system block diagram showing an embodiment of the present invention;

FIGS. 6A, 6B and 6C are schematic diagrams showing top, side and front views of a computer PCB assembly according to one embodiment of the present invention.

### DETAILED DESCRIPTION OF THE PREFERRED EMBODIMENTS

Embodiments of the present invention provide designers, manufacturers of electronic devices, for example computer systems, with solutions to reduce design and manufacturing costs and shorten the turn-around time required to change, modify and/or customize the external I/O interfaces or addition/removal of I/O ports without the need of redesigning and/or replacing the whole main board.

Embodiments of the present invention are configured with a customizable external I/O interface. A base I/O card is provided to couple to a main board, via a base I/O connector. The base I/O connector may be fixed to the main board, and the base I/O card is formed with printed circuits connection terminals. The base I/O connector further has a socket for receiving the base I/O card via the printed circuits connection terminals. Alternatively, the base I/O connector may be fixed to the base I/O card, and the main board is formed with printed circuits connection terminals. By virtue of the above-illustrated configuration, the base I/O card is able to detachably couple to the main board via the base I/O connector.

Embodiments of the present invention provide highly customizable circuit boards for electronics devices, such as computer systems. The circuit boards are configured in such a manner that multiple I/O cards which provide different external interfaces can be interchangeably connected to the main board. The I/O modules are fabricated on separate PCBs, which can be detachably connected to main board via the base I/O connector, or an I/O riser connector assembly.

It can be appreciated that, in the event that there is a need to modify or reconfigure the external interface, it no longer requires to redesign and re-fabricate the entire main board. Instead, the base I/O card may be disconnected from the main board, by unplugging the base I/O card from the main board. Any modification, redesign or customization will be carried out on the base I/O card only. The main board where the central processing unit (CPU) and other components/circuits are located, can be left untouched. The present invention therefore enhances the efficiency of designing, producing and customizing the computer systems.

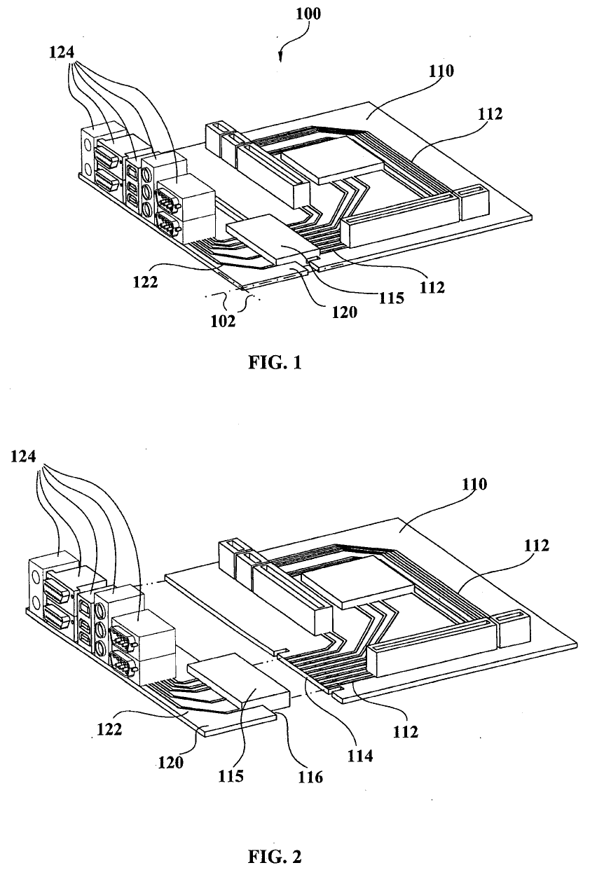

Reference is now made to FIGS. 1, 2 and 3. A computer system PCB assembly 100 according to one embodiment of the present invention includes a first circuit board, such as a main board 110 and a base I/O card 120. Main board 110 has formed thereon first set of printed circuits 112, which provides all necessary Input/Output (I/O) electrical connections to the base I/O card 120. Base I/O card 120 has connecting circuits 122 connected to various External I/O ports 124, such as PS2 ports, serial ports, RJ45 ports and/or speaker In/Out ports.

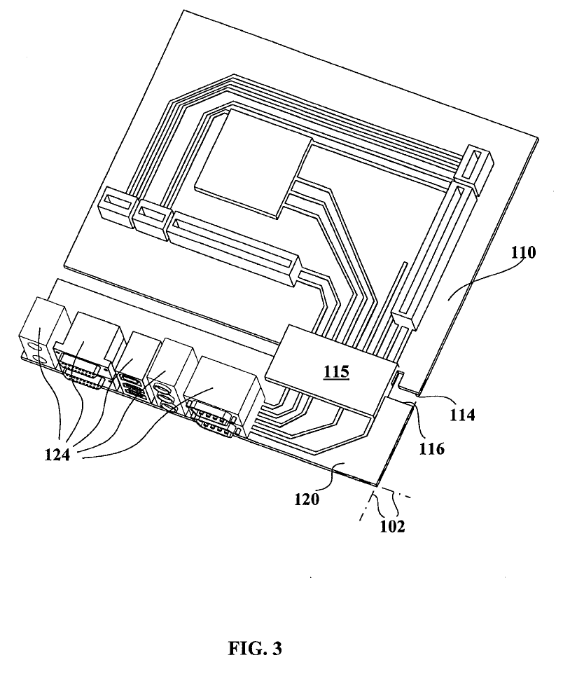

A base I/O connector 115 is provided. The base I/O connector 115 may be fixed to base I/O card 120, as shown in FIG. 2. Under this configuration, main board 110 is formed with base I/O circuitries 112 terminated at a main board edge 114. When base I/O card 120 is to be connected to main board 110, base I/O connector 115 is brought into engagement to main board edge 114 of. Base I/O card 120 is therefore physically fixed to main board 110, with I/O card edge 116 facing against main board edge 114 and in the meantime, base I/O circuitries 112 are electrically connected to connecting circuits 122 which is in turn electrically connected to external I/O ports 124, as shown in FIG. 1. An example of pin definitions assigned to a base I/O connector 115 is set out in Table 1 below:

TABLE 1
Pin Definition of a Base I/O Connector

| Signal Name | Pin | Pin | Signal Name |
|---|---|---|---|
| GND | 61B1 | 1A1 | GND |
| DCD2# | 62B2 | 2A2 | DCD1# |
| DSR2# | 63B3 | 3A3 | DSR1# |
| RX2 | 64B4 | 4A4 | RX1 |
| RTS2# | 65 B5 | 5 A5 | RTS1# |
| TX2 | 66B6 | 6A6 | TX1 |
| CTS2# | 67B7 | 7A7 | CTS1# |
| DTR2# | 68B8 | 8A8 | DTR1# |
| RI2# | 69B9 | 9A9 | RI1# |
| GND | 70B10 | 10A10 | GND |
| +5 V | 71 B11 | 11A11 | +5 V |
| GND | 72B12 | 12A12 | GND |
| OC0 | 73B13 | 13A13 | STB# |
| GND | 74B14 | 14A14 | AFD# |
| USBD1− | 75B15 | 15A15 | PD0 |
| USBD1+ | 76B16 | 16A16 | EER# |
| GND | 77B17 | 17A17 | PD1 |
| USBD0− | 78B18 | 18A18 | INIT# |
| USBD0+ | 79B19 | 19A19 | PD2 |
| GND | 80B20 | 20A20 | SLIN# |
| +5VSB | 81B21 | 21A21 | PD3 |
| GND | 82B22 | 22A22 | PD4 |
| RXAVDD | 83B23 | 23A23 | PD5 |
| LED_LINK | 84B24 | 24A24 | PD6 |
| LED_ACT | 85 B25 | 25A25 | PD7 |
| GND | 86B26 | 26A26 | ACK# |
| TD+ | 87B27 | 27A27 | BUSY |
| TD− | 88B28 | 28A28 | PE |
| GND | 89B29 | 29A29 | SLCT |
| RD+ | 90B30 | 30A30 | GND |
| RD− | 91 B31 | 31A31 | +5 V |
| GND | 92B32 | 32A32 | GND |
| +5 V | 93B33 | 33A33 | TX2N |
| GND | 94B34 | 34A34 | TX2P |
| DVI-R | 95B35 | 35A35 | GND |
| DVI-G | 96B36 | 36A36 | TX1N |
| DVI-B | 97B37 | 37A37 | TX1P |
| GND | 98B38 | 38A38 | GND |
| DVI_HSY | 99B39 | 39A39 | TX0N |
| DVI_VSY | 100B40 | 40A40 | TX0P |
| GND | 101B41 | 41A41 | GND |
| DDC_SDA | 102B42 | 42A42 | TXCN |
| GND | 103B43 | 43A43 | TXCP |
| DDC_SCL | 104B44 | 44A44 | GND |
| GND | 105B45 | 45A45 | DVIDDCCLK |
| +5 V | 106B46 | 46A46 | GND |
| +5 V | 107B47 | 47A47 | DVIDDCDAT |
| GND | 108B48 | 48A48 | GND |
| +5VSB | 109B49 | 49A49 | EDGE |
| CON KEY | | | CON KEY |
| CON KEY | | | CON KEY |
| BVCC | 110B50 | 50A50 | LOUTL |
| GND | 111B51 | 51A51 | LOUTR |
| KBDA | 112B52 | 52A52 | LINL |
| MSDA | 113B53 | 53A53 | LINR |
| GND | 114B54 | 54A54 | GND |
| KBCL | 115B55 | 55A55 | MIC |
| GND | 116B56 | 56A56 | GND |
| MSCL | 117B57 | 57A57 | VREF0 |
| GND | 118B58 | 58A58 | GND |
| +5VSB | 119B59 | 59A59 | +12 V |
| +5VSB | 120B60 | 60A60 | +12 V |

No connecting cable is required to provide electrical connections between main board 110 and base I/O card 120. Reliability issues caused by connecting cables are therefore avoided.

Depending on the design requirement, base I/O card 120 and main board 110 may be disposed with various relative positional relationships. In one example, when coupled together, base I/O card 120 and main board 110 are disposed within a same plane, represented by dash lines 102 intersecting base I/O card 120 and main board 110, as shown in FIGS. 1 and 3.

When there is a need to modify and/or redesign the external I/O ports 124, base I/O card 120 can be conveniently detached from main board 110, by unplugging the base I/O connector 115 from the main board 110. After being detached, the base I/O card 120 can be modified, reconfigured or redesigned, without affecting the main board 110. After the completion of the modification or reconfiguration, the base I/O card 120 may be reconnected to main board 110, by plugging the base I/O connector to the main board edge 114, to resume the functions of the computer system.

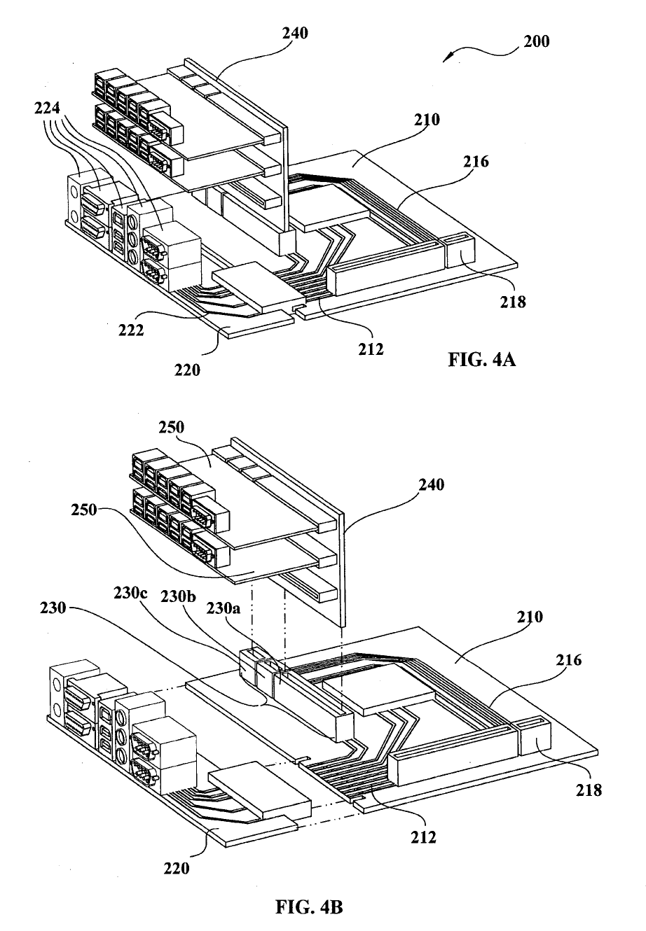

FIGS. 4A and 4B are perspective views of a computer system PCB assembly 200 according to another embodiment of the present invention. PCB assembly 200 has a main board 210 and a base I/O card 220. Main board 210 has formed thereon first set of printed circuits 212, which provides base Input/Output (I/O) electrical connections. Base I/O card 220 has connecting circuits 222 connected to External I/O ports 224, such as PS2 ports, serial ports, RJ45 ports and/or speaker In/Out ports fixed on the base I/O card 220.

In the present embodiment, main board 210 further has an I/O riser connector 230 formed thereon. An I/O riser card 240 is provided, which can be coupled to main board 210 via I/O riser connector 230. Additional I/O cards 250 may be interchangeably connected to I/O riser card 240. Additional I/O cards 250 together with base I/O card 220 therefore provide users with a wide variety of choices to customize the I/O port configurations. Embodiments of the present invention therefore enables customization, modification or redesigning of the external I/O ports or modules of electronics devices, such as computer systems, in a convenient way, at low cost and with a shortened turn-around time.

In one embodiment, I/O riser connector 230 includes a main connector 230a and two edge connectors 230b and 230c. An example of pin definitions of the main connector is set out in Table 2 below. Necessary printed circuits 216 are formed on main board 210 to provide electrical connections from PCI slot 218 to main connector 230a, edge connectors 230b and/or 230c of I/O riser connector 230. The electrical connections provided by printed circuits 216 serve the same purpose of those provided by connection cables used in conventional computer systems, to connect the PCI slots to I/O riser connector 230. As such, connection cables are eliminated in computer systems according to embodiments of the present invention, in supporting additional I/O cards. Examples of pin definitions of the edge connectors are set out in Tables 3 and 4 below.

TABLE 2
Pin Definition of a main Connector of an I/O riser connector

| Signal Name | Pin | Pin | Signal Name |
|---|---|---|---|
| −12 V | 61B1 | 1A1 | NC |
| CLK2 | 62B2 | 2A2 | +12 V |
| GND | 63B3 | 3A3 | TMS |
| TD0 | 64B4 | 4A4 | TDI |
| +5 V | 65 B5 | 5 A5 | +5 V |
| +5 V | 66B6 | 6A6 | INTA# |
| INTB# | 67B7 | 7A7 | INTC# |
| INTD# | 68B8 | 8A8 | +5 V |
| PRSNT#1 | 69B9 | 9A9 | RESRVED |
| RESERVED | 70B10 | 10A10 | +5 V |
| PRSNT#2 | 71 B11 | 11A11 | RESRVED |
| GND | 72B12 | 12A12 | GND |
| GND | 73B13 | 13A13 | GND |
| RESERVED | 74B14 | 14A14 | RESRVED |
| GND | 75B15 | 15A15 | RST# |
| CLK1 | 76B16 | 16A16 | +5 V |
| GND | 77B17 | 17A17 | GNT |
| REQ# | 78B18 | 18A18 | GND |
| +5 V | 79B19 | 19A19 | PME |
| AD31 | 80B20 | 20A20 | AD30 |
| AD29 | 81B21 | 21A21 | +3.3 V |
| GND | 82B22 | 22A22 | AD28 |
| AD27 | 83B23 | 23A23 | AD26 |
| AD25 | 84B24 | 24A24 | GND |
| +3.3 V | 85 B25 | 25A25 | AD24 |
| C_BE#3 | 86B26 | 26A26 | IDSEL |
| AD23 | 87B27 | 27A27 | +3.3 V |
| GND | 88B28 | 28A28 | AD22 |
| AD21 | 89B29 | 29A29 | AD20 |
| AD19 | 90B30 | 30A30 | GND |
| +3.3 V | 91 B31 | 31A31 | AD18 |
| AD17 | 92B32 | 32A32 | AD16 |
| C_BE#2 | 93B33 | 33A33 | +3.3 V |
| GND | 94B34 | 34A34 | FRAME# |
| IRDY# | 95B35 | 35A35 | GND |
| +3.3 V | 96B36 | 36A36 | TRDY |
| DEVSEL# | 97B37 | 37A37 | GND |
| GND | 98B38 | 38A38 | STOP |
| LOCK# | 99B39 | 39A39 | +3.3 V |
| PERR# | 100B40 | 40A40 | SDONE |
| +3.3 V | 101B41 | 41A41 | SBO |
| SERR# | 102B42 | 42A42 | GND |
| +3.3 V | 103B43 | 43A43 | PAR |
| C_BE#1 | 104B44 | 44A44 | AD15 |
| AD14 | 105B45 | 45A45 | +3.3 V |
| GND | 106B46 | 46A46 | AD13 |
| AD12 | 107B47 | 47A47 | AD11 |
| AD10 | 108B48 | 48A48 | GND |
| GND | 109B49 | 49A49 | AD9 |
| CON KEY | | | CON KEY |
| CON KEY | | | CON KEY |
| AD8 | 110B50 | 50A50 | C_BE#0 |
| AD7 | 111B51 | 51A51 | 3.3 V |
| +3.3 V | 112B52 | 52A52 | AD6 |
| AD5 | 113B53 | 53A53 | AD4 |
| AD3 | 114B54 | 54A54 | GND21 |
| GND | 115B55 | 55A55 | AD2 |
| AD1 | 116B56 | 56A56 | AD0 |
| +5 V | 117B57 | 57A57 | +5 V |
| ACK64# | 118B58 | 58A58 | REQ64# |
| +5 V | 119B59 | 59A59 | +5 V |
| +5 V | 120B60 | 60A60 | +5 V |

TABLE 3
Pin Definition of first edge Connector of an I/O riser connector

| Signal Name | Pin | Pin | Signal Name |
|---|---|---|---|
| DCD3# | 12B1 | 1A1 | DSR3# |
| RX3 | 13B2 | 2A2 | RTS3# |
| TX3 | 14B3 | 3A3 | CTS3# |
| DTR3# | 15B4 | 4A4 | RI3# |
| GND | 16B5 | 5A5 | GND |
| DCD4# | 17B6 | 6A6 | DSR4# |
| RX4 | 18B7 | 7A7 | RTS4# |
| TX4 | 19B8 | 8A8 | CTS4# |
| DTR4# | 20B9 | 9A9 | RI4# |
| GND | 21B10 | 10A10 | GND |
| GPIO43 | 22B11 | 11A11 | GPIO42 |

TABLE 4
Pin Definition of a second edge Connector of an I/O riser
connector

| Signal Name | Pin | Pin | Signal Name |
|---|---|---|---|
| LPC_AD3 | 12B1 | 1A1 | LPC_AD1 |
| LPC_AD2 | 13B2 | 2A2 | LPC_AD0 |
| LPC_FRAME# | 14B3 | 3A3 | LPC_DRQ0# |
| GND | 15B4 | 4A4 | GND |
| USB2− | 16B5 | 5A5 | USB2− |
| USB2+ | 17B6 | 6A6 | USB2+ |
| GND | 18B7 | 7A7 | GND |
| OC2 | 19B8 | 8A8 | GPIO41 |
| GND | 20B9 | 9A9 | GPIO40 |
| GPIO39 | 21B10 | 10A10 | GPIO37 |
| GPIO38 | 22B11 | 11A11 | GPIO23 |

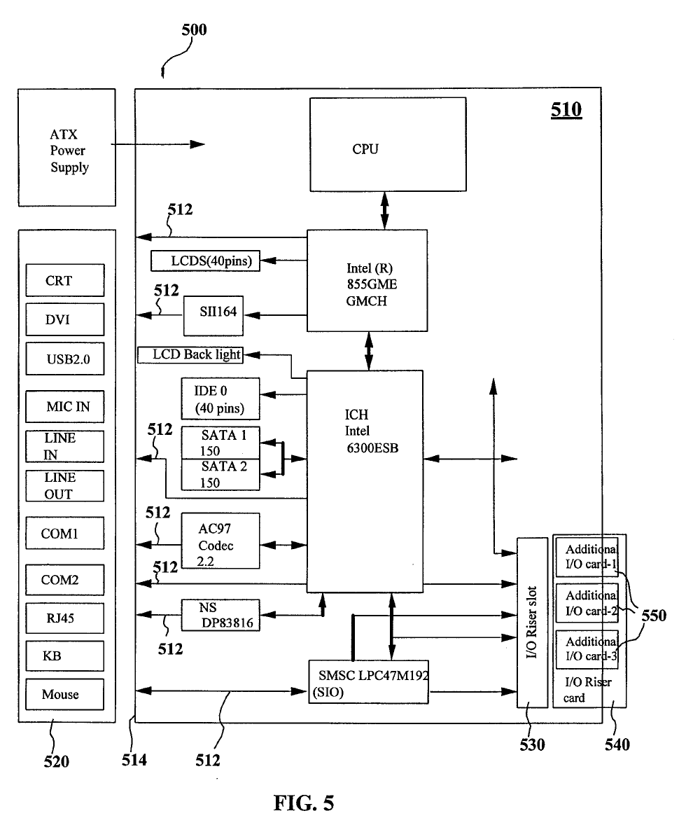

FIG. 5 is a block diagram showing a computer system 500 according to an embodiment of the present invention. Base I/O circuitries or connections 512 are formed on the main board 510, and terminated at a main board edge 514, to provide electrical connections to a base I/O card 520. Additional I/O circuitries or connections 516 are also formed on the main board 510, to connect to an I/O riser slot 530 which is configured to receive three additional I/O cards 550 via an I/O riser card 540.

Base I/O card 520 and additional I/O cards 550 are all detachably coupled to main board 510, via main board edge 514 and I/O riser slot 530, respectively.

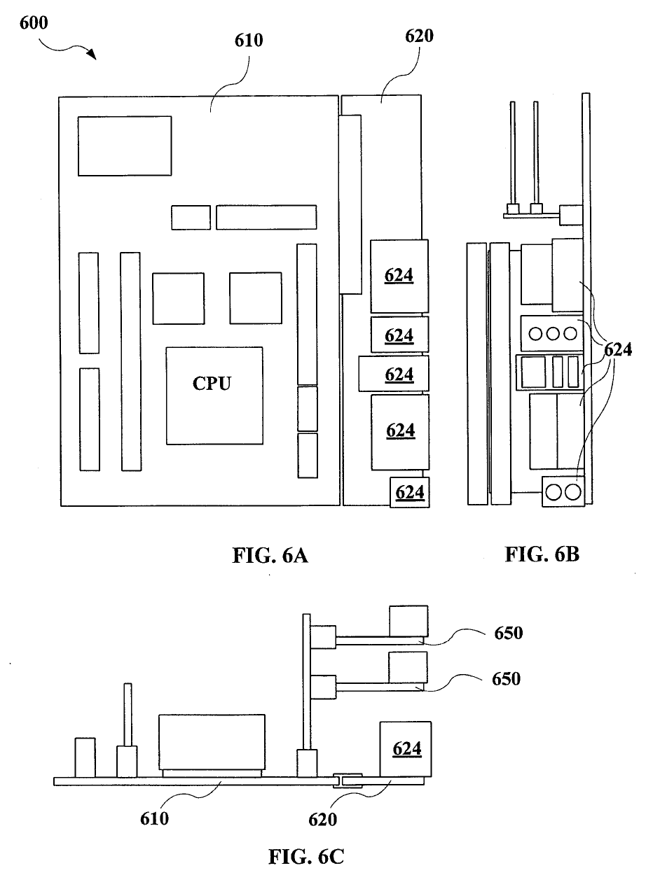

FIGS. 6A, 6B and 6C are schematic diagrams showing a computer system PCB assembly 600 according to a further embodiment of the present invention. According to this embodiment, a base I/O card 620 coupled to various external I/O ports or modules 624 and two additional interchangeable I/O cards 650 are detachably connected to a main board 610.

Although embodiments of the present invention have been illustrated in conjunction with the accompanying drawings and described in the foregoing detailed description, it should be appreciated that the invention is not limited to the embodiments disclosed, and is capable of numerous rearrangements, modifications, alternatives and substitutions without departing from the spirit of the invention as set forth and recited by the following claims.

1. A computer system comprising:
a main board;
a base I/O card detachably coupled to the main board;
wherein the main board and the base I/O card are within a same plane when coupled together.

2. The computer system of claim 1, wherein the main board having a set of base I/O circuitries terminated at a main board edge, and wherein the base I/O card is detachably coupled to the main board at the main board edge.

3. The computer system of claim 2, wherein the base I/O card is detachably coupled to the main board with an I/O card edge facing against a main board edge.

4. The computer system of claim 2, wherein the main board having a set of additional I/O circuitries connected to a riser connector, wherein the computer system further comprises a plurality of additional I/O cards detachably coupled to the riser connector via a riser card.

5. The computer system of claim 4, wherein the plurality of additional I/O cards are disposed parallel to the base I/O card.

6. The computer system of claim 4, wherein the plurality of additional I/O cards are interchangeably coupleable to the riser card.

7. A computer system comprising:
a main board;
a base I/O card having a plurality of I/O ports fixed thereon for coupling to external I/O devices;
wherein the base I/O card is detachably coupled to the main board with an I/O card edge facing against a main board edge.

8. The computer system of claim 7, wherein the main board having a set of base I/O circuitries terminated at the main board edge for connecting to the base I/O card.

9. The computer system of claim 8, wherein the main board having a set of additional I/O circuitries connected to a riser connector, wherein the computer system further comprises a plurality of additional I/O cards detachably coupled to the riser connector via a riser card.

10. The computer system of claim 9, wherein the plurality of additional I/O cards are disposed parallel to the base I/O card.

11. The computer system of claim 9, wherein the plurality of additional I/O cards are interchangeably coupleable to the riser card.

12. A computer system comprising:
a first circuit board having a first set of I/O circuitries terminated at a first board edge;
a second circuit board having at least one I/O port coupled thereon and a second set of I/O circuitries terminated at a second board edge;
wherein the first and second circuit boards are detachably coupled to each other via an engagement of the first board edge and the second board edge.

13. The computer system of claim 12, wherein the main board further comprises a third set of I/O circuitries connected to a riser connector and a plurality of additional I/O cards detachably coupled to the main board via the riser connector.

14. The computer system of claim 13, wherein the plurality of additional I/O cards are disposed parallel to the base I/O card.

15. The computer system of claim 13, wherein the plurality of additional I/O cards are interchangeably coupleable to the riser card.
